(19) United States
(12) Patent Application Publication
(10) Pub. No.: US 2021/0115928 A1
(43) Pub. Date: Apr. 22, 2021

(54) PRESSURE SENSOR WITH INTEGRATED PUMP CONTROL

(71) Applicant: GRUNDFOS HOLDING A/S, Bjemingbro (DK)

(72) Inventors: Carsten NIELSEN, Viborg (DK); Morten ØDUM HALSE, Bjerringbro (DK)

(21) Appl. No.: 16/970,559

(22) PCT Filed: Jan. 22, 2019
(86) PCT No.: PCT/EP2019/051455

§ 371 Date: Aug. 17, 2020

(30) Foreign Application Priority Data
Feb. 19, 2018 (EP) 18157404.7

(51) Int. Cl. F04D 15/00; F04D 13/06; G08C 17/00

(52) U.S. Cl. CPC F04D 15/0066; G08C 17/00; F04D 13/0686

(57) ABSTRACT

A pump system (1) includes a first (3) of at least one pump unit (3, 5) for pumping a fluid (11). The first pump unit (3) includes a pump, an electrical drive motor and a motor control, with a pump control for commanding the motor control. A sensor (7) with a sensor housing (27) and with sensor electronics (28) are located in the sensor housing (27) for detecting at least one parameter of the fluid (11) in the pump or in a pipe which is fluid-connected to the pump The pump control is integrated into the sensor electronics (28).

### CROSS REFERENCE TO RELATED APPLICATIONS

This application is a United States National Phase Application of International Application PCT/EP2019/051455, filed Jan. 22, 2019, and claims the benefit of priority under 35 U.S.C. §119 of European Application 18157404.7, filed Feb. 19, 2018, the entire contents of which are incorporated herein by reference.

### TECHNICAL FIELD

The present disclosure relates to a pump system with one or more pumps and to a pump control method for this. It is preferably the case of one or more wet-running circulation pumps which are designed as single-stage or multi-stage centrifugal pumps for pumping water.

### TECHNICAL BACKGROUND

Known systems with a plurality of pumps comprise programmable logic controllers PLC which control the interaction of the pumps. U.S. Pat. No. 9,670,918 B2 for example describes a booster system with a PLC, with which one attempts to determine optimal switch-on parameters for the pumps.

### SUMMARY

In contrast, the present disclosure provides a pump system and pump control system which make do without such a PLC and therefore reduce the complexity and costs of the system.

According to a first aspect of the present disclosure, a pump system is provided, with a first of at least one pump unit for pumping a fluid, wherein the first pump unit comprises a pump, an electrical drive motor and a motor control, with a pump control for commanding the motor control, and with a sensor with a sensor housing and with sensor electronics which are arranged in the sensor housing for detecting at least one parameter of the fluid in the pump or in a pipe which is fluid-connected to the pump, wherein the pump control is integrated into the sensor electronics.

The pump system which is disclosed herein therefore utilises the sensor electronics which are located in the sensor, in order to make do without the complex and costly PLC and to command the pump(s) directly from the sensor. The “motor control” here is to comprise those power-electronic components which control the operating current through the coils of the drive motor, such as for instance a frequency converter. Herein, the term “to command” in the context of an activation is to be understood in that command signals are sent from the pump control to the motor control and determine the operating manner of the drive motor, for example a switch-on and/or switch-off signal, a desired speed and/or desired power consumption. Although the sensor electronics can additionally also provide measuring signals, the provision of measuring signals here however is not to be misunderstood as a commanding, even if a pump control renders the operating manner of the motor dependent on a measuring signal. The present disclosure is therefore to be differentiated from systems, concerning which a pump control outside the sensor receives a measuring signal from the sensor and renders the operating manner of the drive motor dependent on a measuring signal. Such a sensor-external pump control is indeed spared due to the pump control of the present disclosure which is integrated into the sensor electronics. The pump control can be integrated into the sensor electronics in the form of software, without necessitating a change of the sensor electronics which usually only provide measuring signals. Any hardware components which are present in the sensor electronics, such as memory, processor, interface and signal connection which are usually used for providing measuring signals can be used here for commanding the motor control. Alternatively or additionally, one or more such hardware components can be adapted to the commanding of the motor control, thus be extended.

Optionally, the sensor can be attachable to the pump or to a pipe which is fluid-connected to the pump, at a measuring location. Herein, the sensor is preferably arranged externally of a housing for the motor control. The sensor electronics are hereby preferably designed for the direct detection of at least one parameter of the fluid in the pump or in a pipe which is fluid-connected to the pump. For this, the sensor preferably comprises a sensor surface which on operation of the sensor is in direct contact with the fluid to be pumped, said fluid being in the pump or in a pipe which is fluid-connected to the pump.

The sensor can optionally be signal-connected to the motor control, wherein the pump control which is integrated into the sensor electronics can command the motor control via the signal connection. Such a signal connection can be effected in a wireless manner or via cable connection. The command signals of the pump control for commanding the motor control can be digital and/or analog.

The at least one parameter of the fluid which is to be detected by the sensor can optionally comprise a fluid temperature, a fluid pressure, a fluid flow rate and/or a fluid vibration. The at least one sensor can therefore be a temperature sensor, a pressure sensor, a flow rate sensor and/or a vibration sensor. A plurality of sensors for different parameters of the fluid which are to be detected, such as for instance fluid temperature, a fluid pressure, a fluid flow rate, a fluid vibration and/or a vibration of the at least one pump unit and/or parts of this can be arranged in a common sensor housing. A fluid vibration here is also to be understood as a number, a frequency, an amplitude and/or a temporal integral of pressure pulses which can be caused in the pipe system for example due to the closure of a valve.

The pump system can optionally comprise a sensor mains part for supplying the sensor with electricity. The sensor mains part can be designed separately from the at least one sensor with the pump control and supply the sensor with electricity preferably via a cable connection. Herein, the sensor mains part can additionally serve for a communication with the sensor via the cable connection between the sensor mains part and the sensor. The sensor mains part can moreover not only serve for the electricity supply of the sensor, but also of the drive motor and/or the motor control of the at least one pump unit. For this, the sensor mains part can comprise an additional cable connection to the drive motor and/or to the motor control of the at least one pump unit.

Optionally, the pump system can comprise a sensor communication interface, via which the pump control is programmable. Herein, the sensor communication interface can be integrated into the sensor electronics and/or the sensor mains part. If the sensor communication interface is integrated at least partly into the sensor mains part, then the programming of the pump control can be led via the cable connection between the sensor main part and the sensor to the pump control in the sensor.

The pump system can optionally comprise a mobile communication device, by way of which the pump control is programmable via a preferably wireless communication connection to the sensor communication interface. Such a communication device can for example be a notebook, tablet or smartphone which can communicate with the sensor communication interface via a preferably wireless communication connection such as Bluetooth or WLAN. A user can program the pump control and/or adjust operating parameters of one or more pump units by way of an executable program such as for instance an app on the communication device. In this context, what is means by “programming” for example is as an upload or update of an operating program, a selection of a plurality of available operating programs and/or the adjusting of one or more operating parameters such as for instance desired speed, desired delivery head, desired flow rate, desired power and/or on/off. The communication connection between the communication device and the sensor communication interface can be a two-way communication connection, by way of which the communication device can inform the user a regard to operating parameters, error notices, alarms, measured values and/or available operating programs, visually via a display or a light and/or acoustically. The data can also be stored on the communication device, a server and/or within the framework of a cloud-based solution, for statistical evaluation and/or error analysis.

The pump system can optionally comprise a control interface which is signal-connected to the motor control and via which the motor control of the first pump unit is commandable by way of the pump control. The control interface can be integrated for example into the sensor electronics and/or sensor mains part. If the control interface is integrated at least partly into the sensor mains part, then the commanding of the motor control can be led from the pump control in the sensor to the sensor mains part via the cable connection between the sensor mains part and the sensor.

Optionally, the pump control can be configured to command the motor control on the basis of the at least one parameter of the fluid which is detected by the sensor. Additionally, one or more convention sensors such as for instance temperature sensors, pressure sensors, flow rate sensors and/or vibration sensors, concerning which the pump control is not integrated into the sensor electronics, can additionally also be provided. These conventional sensors can provide the at least one sensor with the pump control with measurement signals via a communication connection, in order to be able to use these for the pump control. For example, with a plurality of pump units, a sensor with a pump control can be provided on one pump unit, whereas conventional sensors can be provided on the other pumps. The at least one sensor with the pump control can thereby control the plurality of the pump units on account of the fluid parameter which it itself detects as well as the fluid parameters which are detected by the conventional sensors.

The pump control can optionally be configured to command the motor control of the first pump unit in accordance with a selectable operating program. The operating program is preferably selectable by way of an executable program such as an app on a mobile communication device.

The pump system can optionally comprise a second of at least one pump units for pumping the fluid, wherein the pump control is configured to command the motor control of the first pump unit and/or a motor control of the second pump unit in accordance with a selectable operating program. The pump control in the sensor can control two or more pump units according to a selectable operating program. For this, the at least one sensor can be directly or indirectly signal-connected to the respective motor control of each of the pump units to be controlled.

Optionally, the pump control can be configured to command the motor control of the first pump unit and/or a motor control of a second pump unit with operating parameter commands, such as for example switch-on and switch-off commands, desired speed commands, desired delivery head commands, desired flow rate commands and/or desired power commands.

According to a second aspect of the present disclosure, a pump control method with the following steps is provided:
detecting at least one parameter of a fluid in a pump of a first of at least one pump unit or in a pipe which is fluid-connected to the pump, by way of a sensor and
commanding a motor control of the first pump unit by way of a pump control which is integrated into the sensor electronics of the sensor.

Optionally, the pump control method can moreover comprise the step of a programming of the pump control via a sensor communication interface which is integrated into the sensor electronics and/or a sensor mains part. Such a programming can preferably be effected by way of a mobile communication device and via a preferably wireless communication connection between the communication device and the sensor communication interface.

The step of the commanding can optionally be effected on the basis of the at least one parameter of the fluid which is detected by way of the sensor. Alternatively or additionally, parameters of the fluid can be detected by other conventional sensors without an integrated pump control and be made available to the at least one sensor with an integrated pump control, in order for the commanding of the motor control(s) to be based on these.

Optionally, the step of the commanding can comprise an operating parameter command, such as for example a switch-on and switch-off command, a desired speed command and/or desired power command, for a drive motor of the first pump unit in accordance with a selectable operating program.

Optionally, the pump control method can moreover comprise the following step:
commanding a motor control of a second of at least two pump units by way of the pump control which is integrated into the sensor electronics of the sensor, with operating parameter commands, such as for example switch-on and switch-off commands, desired speed commands and/or desired power commands.

These operating parameter commands can preferably correspond to a selectable operating program. Optionally, the operating program can herein be selectable from a group of operating programs with a first operating program, concerning which the second pump unit is connected as an supplementary unit to the first pump unit as a main unit if the detected at least one parameter of the fluid indicates that the power of the first pump unit is not sufficient, wherein preferably the second pump unit serves as main unit and the first pump unit as a supplementary unit in an alternating schedule.

Optionally, in a second selectable operating program, concerning which only the first pump unit is switched on as a main unit, only the second pump unit as a main unit is switched on in an alternating schedule. In an optional third selectable operating program, the first and the second pump unit can be switched on. The first and second pump unit can also both be selectively switched off.

Optionally, the pump control method can moreover comprise the step of detecting the number of switch-on procedures and/or the operational running time of the first and/or the second pump unit, wherein the step of the commanding is effected on the basis of the detected number of switch-on procedures and/or the detected operational running time of the first and/or second pump unit.

The disclosure is hereinafter explained in more detail by way of embodiment examples which are represented in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of an embodiment example of the pump system which is disclosed herein;

FIG. 2a is an end view of an embodiment example of a sensor according to the pump system which is disclosed herein;

FIG. 2b is a side view of the embodiment example of a sensor according to the pump system which is disclosed herein;

FIG. 2c is a sectional view taken along line B-B of FIG. 2b of the embodiment example of a sensor according to the pump system which is disclosed herein;

FIG. 2d is a detail sectional view of area C of FIG. 2c of the embodiment example of a sensor according to the pump system which is disclosed herein;

FIG. 2e is a sectional view taken along line A-A of FIG. 2a of the embodiment example of a sensor according to the pump system which is disclosed herein;

FIG. 3 is a schematic view of an embodiment example of the pump control method which is disclosed herein.

### DESCRIPTION OF PREFERRED EMBODIMENTS

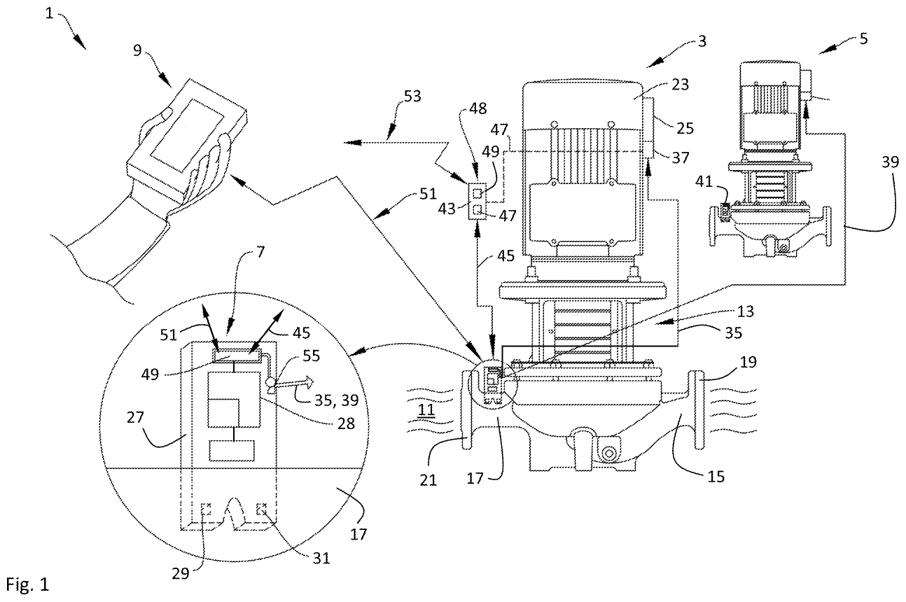

Referring to the drawings, FIG. 1 shows a pump system 1 with a first pump unit 3, a second pump unit 5, a first sensor 7 and a mobile communication device 9. The first pump unit 3 and the second pump unit 5 are connected to a pipe system which is not shown here, in order to pump a fluid 11, preferably water, therein. The first pump unit 3 and the second pump unit 5 can thereby be connected in the pipe system in series or parallel to one another. The pump system 1 can also comprise several pump units in series and/or parallel to one another. The pumps units 3, 5 in this embodiment example are of the same type and specifically a multi-stage centrifugal pump assembly with a vertical rotor axis. In alterative embodiments, the pump units of the pump system can be of a different size and/or different type, for example one or more of the pump units can only be a single-stage pump assembly with a vertical or horizontal rotor axis. Moreover, it does not necessarily need to be the case of centrifugal pump assemblies, and other pump types can also be applied.

The first pump unit 3 here comprises a pump housing 13 with a suction branch 15 (suction stub connection) and a delivery branch 17 with associated flanges 19, 21 for the connection to the pipe system which is not shown here. The fluid 11 to be pumped is sucked at the suction branch 15 and is pumped to the delivery branch 17. A plurality of impellers is arranged in a stepped manner over one another about a vertical rotor shaft within the pump casing 13. The rotor shaft is driven by an electric drive motor within a motor housing 23 which is arranged above the pump casing 13. An electronics housing 25, in which a motor control with a frequency converter is located, in order to provide the operating current for the drive motor, is arranged on the motor housing 23. In an alternative embodiment, the motor control can at least partly be integrated in the motor housing 23, so that no separate electronics housing 25 is necessary or the electronic housing 25 is integrated in the motor housing 23 as a region.

In this embodiment example, the first sensor 7 is arranged at a measuring location on the delivery branch 17 of the pump casing 13 for detecting at least one parameter of the fluid 11 in the delivery branch 17 of the first pump unit 3. In an alternative embodiment, the first sensor 7 can be arranged remotely from the first pump unit 3, for example at a measuring location on a pipe of the pipe system which is connected to the first pump unit 3, in order to detect at least one parameter of the fluid 11 in the pipe which is fluid-connected to the pump. The first sensor 7 comprises a sensor housing 27 and sensor electronics 28 which are located in the sensor housing 27. The first sensor 7 moreover comprises sensing elements 29, 31 which at least partly project into the fluid 11 to be pumped, whereas the sensor housing 27 is arranged completely or at least partly outside the delivery branch 17. The sensing elements 29, 31 can be designed to measure the fluid temperature, the fluid pressure, the fluid flow and/or the fluid vibration as a parameter of the fluid 11. Alternative or additionally to a fluid vibration, the vibration of one of the pump units 3, 5 or parts of these and/or of a pipe which is fluid-connected to one of the pump units 3, 5 can also be measured. Here for example, a number, a frequency, an amplitude and/or a temporal integral of pressure pulses, able to be caused in the pipe system for example by way of closing the valve, can also be understood as a fluid vibration.

A pump control, with which the motor control in the electronics housing 25 of the first pump unit 3 can be commanded, is integrated into the sensor electronics 28 in the sensor housing 27. For this, a first signal connection 35 for transmitting commands via a pump-side interface 37 exists between the sensor electronics 28 and the motor control in the electronics housing 25. The first signal connection 35 can be effected in a wireless manner or via cable. In this embodiment example, the first sensor 7 is additionally connected to the motor control of the second pump unit 5 via a second signal connection 29, in order to be able to command this too. Here, a second sensor 41 is attached to a delivery branch of the second pump unit 5 and only conventionally detects at least one parameter of the fluid and no pump control is integrated into the sensor electronics. In an alternative embodiment, the second sensor 41, just as the first sensor 7, can be provided with a pump control which is integrated into the sensor electronics, in order to command the motor control of the first pump unit 3 and/or the second pump unit 5.

In this embodiment, the first sensor 7 is supplied with electricity by a sensor mains part 43. For this, the sensor mains part 43 is connected to the first sensor 7 via a cable connection 45. For this, the sensor mains part 43 can comprise a transformer and/or a rectifier 47, in order, from the mains alternating voltage, to provide a suitable direct voltage for the first sensor 7 via the cable connection 45. The cable connection 45 and/or an additional wireless or cabled communication connection between the first senor 7 and the sensor mains part 43 can serve for the communication between sensor mains part 43 and the sensor 7. Here, the sensor mains part 43 via a cable connection 47 to the pump-side interface 37 can additionally serve for the electricity supply of the drive motor and/or the motor control of the first pump unit 3.

Two possibilities as to how the pump control in the sensor electronics 28 of the first sensor 7 is programmable are shown in the embodiment example which is shown in FIG. 1. For this, a sensor communication interface 49 can be integrated into the sensor electronics 28 and/or the sensor mains part 43. The pump control in the first sensor 7 is programmable via respective, preferably wireless communication connections 51, 53 between the mobile communication device 9, here in the form of a smartphone, and the sensor communication interface 49. The programming of the sensor electronics 28 can be effected via the cable connection 45 in the case that the sensor communication interface 49 is integrated exclusively in the sensor mains part 43.

The commanding of the motor control via the first signal connection 35 and/or the second signal connection 39 is effected here via a control interface 55. The control interface 55, as is shown, can additionally be signal-connected (here via the second signal connection 39) to a motor control of one or more further pump units such as for instance the second pump unit 5, in order to likewise be able to command these. The control interface 55 can be integrated into the sensor electronics 28 (as is shown in FIG. 1) and/or into the sensor mains part 43.

For this, the pump control here is configured to command the motor control of the first pump unit 3 and of the second pump unit 5 on the basis of the at least one parameter of the fluid which is detected by way of the sensor 7. For example, the sensor 7 can be a pressure sensor which provides a signal which correlates to the fluid pressure in the delivery branch 17 as a detected parameter. If the signal exceeds or falls short of a fixed setpoint, then the pump control can command a higher or lower pump speed or pump power of the first pump unit 3 and/or of the second pump unit 5 and/or switch these on or off in accordance with the requirements. For this, the pump control is preferably configured to command the respective motor control of the first pump unit 3 and/or of the second pump unit 5 in accordance with a selectable operating program.

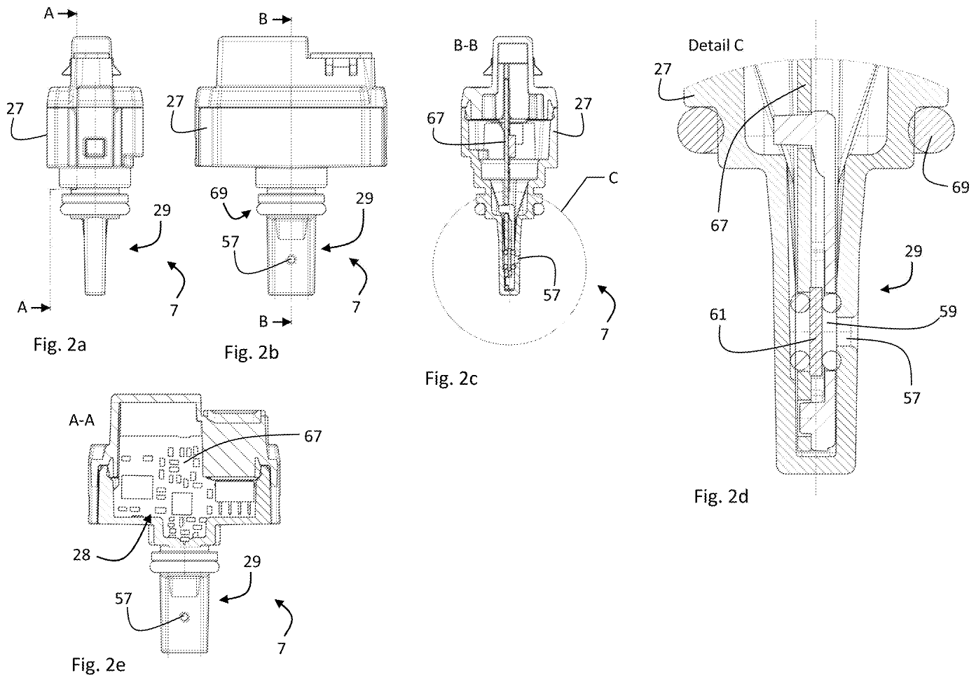

FIGS. 2a-e show the sensor 7, here in the form of a pressure sensor, more precisely from different sides. The lateral view 2a shows the sensor housing 27, which encompasses a lower sensing element 29 and the upper sensor electronics 28. For this, the lower sensing element 29 is designed to project into the fluid to be pumped and is as slim as possible, in order to keep the flow resistance to the fluid which is induced by the sensing element 29 as low as possible. As is shown in the front elevation 2b, the sensing element 29 comprises an opening 57, through which fluid can flow into a sealed-off volume 59 and can come into contact with a pressure probe 61 which projects into the sealed-off volume 59 (see detailed section B-B in FIG. 2d). The fluid pressure upon the pressure probe 61 is detected by way of the sensor electronics 28 which are arranged on a circuit board 67.

The sensor 7 is adapted to a suitable measuring location and above the sensing element 29 comprises closure and sealing means 69, for example in the form of an O-ring, in order to be able to be sealingly installed at a measuring location of the pump unit 3, 5 or of the pipe system. An upper part of the sensor housing 27 which encompasses at least a large part of the sensor electronics 28 lies outside the pump unit 3, 5 of the pipe in the shown embodiment. This part of the sensor housing 27 which lies to the outside can therefore be designed larger than the sensing element 29. The circuit board 67 with the sensor electronics 28 and the pump control which is integrated therein can be designed accordingly large (see section A-A in FIG. 2e). However, the complete sensor housing 27 can alternatively be integrated completely into the pump unit 3, 5 or into the pipe, without a part of the sensor housing 27 projecting out of the pump unit 3, 5 or the pipe.

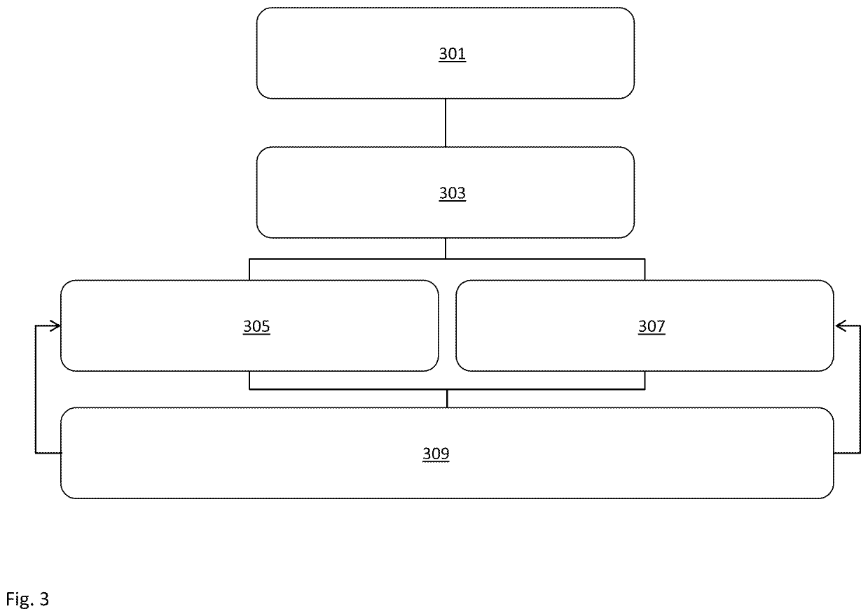

FIG. 3 schematically shows an example of the pump control method which is disclosed herein. Herein, the pump control is firstly programmed 301 via a sensor communication interface 49 which is integrated into the sensor electronics 28 and/or a sensor mains part 43. Such a programming can preferably be effected by way of a mobile communication device and via a preferably wireless communication connection between the communication device and the sensor communication interface. A step of detecting 303 at least one parameter of a fluid in a pump of a first of at least one pump unit 3 or in a pipe which is fluid-connected to the pump is then effected by way of a sensor 7. A motor control of the first pump unit 3 is subsequently commanded by way of the pump control which is integrated into sensor electronics 28 of the sensor 7 and is programmed via the sensor communication interface 49. Optionally, the step of the commanding 305 can be effected on the basis of the at least one parameter of the fluid which is detected by the sensor. Alternatively or additionally, parameters of the fluid can be detected by other conventional sensors without an integrated pump control and be made available to the at least one sensor with an integrated pump control, in order to base the commanding of the motor control(s) on this. Optionally, the step of the commanding 305 can comprise an operating parameter command, such as for example switch-on and switch-off command, desired speed command and/or desired power command for a drive motor of the first pump unit in accordance with a selectable operating program.

Optionally, the pump control method can moreover comprise the following step: commanding 307 a motor control of a second 5 of at least two pump units 3, 5 with operating parameter commands such as for example switch-on and switch-off commands, desired speed commands and/or desired power commands, by way of the pump control which is integrated into the sensor electronics of the sensor. These operating parameter commands can preferably correspond to a selectable operating program. Optionally, the operating program can herein be selectable from a group of operating programs with a first operating program, concerning which the second pump unit as a supplementary unit is connected to the first pump unit 3 as the main unit, if the detected at least one parameter of the fluid indicates that the power of the first pump unit 3 is not sufficient, wherein preferably the second pump unit 5 serves as a main unit and the first pump unit 3 as a supplementary unit in an alternating schedule. Optionally, in a second selectable operating program, concerning which only the first pump unit 3 as a main unit is switched on, only the second pump unit 5 as a main unit is switched on, preferably in an alternating schedule. In an optional, third selectable operating program, the first and second pump unit 3, 5 can be switched on. The first and the second pump unit 3, 5 can also both be selectively switched off.

Finally, during the pump operation, the number of switch-on procedures and/or the operational running time of the first and/or second pump unit 3, 5 is detected 309, wherein the step of the commanding 305, 307 is effected on the basis of the detected number of switch-on procedures and/or the detected operational running time of the first and/or second pump unit 3, 5. The pump units 3, 5 can be burdened as equally as possible by way of this, in order to prevent a premature wearing of one of the pump units. Moreover, a longer period of non-use of one of the pump units is avoided herewith, so that the case, in which a pump which has not been used for some time does not correctly function when used does not arise.

The numbered designations of the components or movement directions as “first”, “second”, “third” etc. have herein only been selected purely randomly, so as to differentiate the components or movement directions from one another, and can be selected arbitrarily differently. They therefore do not imply any status of significance. A designation of a component or technical feature as “first” should not be misunderstood to the extent that there must be a second component or technical feature of this type. Moreover, any method steps, inasmuch as not explicitly stated otherwise or not compelling necessary, can be carried out in an arbitrary sequence and/or in a party or completely overlapping manner with regard to time.

Equivalent embodiments of the parameters, components or functions which are described herein and which, in the light of this description, appear to be evident to the person whose is competently skilled are included herein as if they were explicitly described. Accordingly, the protective scope of the claims is to include such equivalent embodiments. “Can” features which are indicated as optional, advantageous, preferred, desired or similar are to be understood as being optional and not as limiting the protective scope.

The described embodiments are to be understood as illustrative examples and do not represent a final list of possible embodiments. Each feature which has been disclosed in the framework of an embodiment can be used alone or in combination with one or more other features, independently of the embodiment, in which the features have been described in each case. Whereas at least one embodiment is described and shown herein, modifications and alternative embodiments which appear to be evident to a competently skilled person in the light of this description are also included by the protective scope of this disclosure. Moreover, the term “comprise” is neither to exclude additional other features or method steps nor does the term “one” exclude a plurality.

While specific embodiments of the invention have been shown and described in detail to illustrate the application of the principles of the invention, it will be understood that the invention may be embodied otherwise without departing from such principles.

1. A pump system comprising:
a first pump unit for pumping a fluid, wherein the first pump unit comprises a pump, an electrical drive motor and a motor control;
a pump control for commanding the motor control; and
a sensor comprising a sensor housing and sensor electronics, located in the sensor housing, for detecting at least one parameter of the fluid in the pump or in a pipe which is fluid-connected to the pump, wherein the pump control is integrated into the sensor electronics.

2. A pump system according to claim 1, wherein the sensor is attached to the pump or to the pipe which is fluid-connected to the pump, at a measuring location.

3. A pump system according to claim 1, wherein the sensor is signal-connected to the motor control.

4. A pump system according to claim 1, wherein the at least one parameter of the fluid which is to be detected by the sensor comprises a fluid temperature, a fluid pressure, a fluid flow rate, a fluid vibration and/or a vibration of the pump unit and/or parts of the pump unit.

5. A pump system according to claim 1, further comprising a sensor mains part for a supply of electricity to the sensor.

6. A pump system according to claim 5, wherein a communication interface is integrated into the sensor mains part, whereby the sensor mains serves for communication with the sensor via a cable connection between the sensor mains part and the sensor.

7. A pump system according to claim 5, wherein the sensor mains part serves for the electricity supply of the drive motor and/or for the motor control of the pump unit.

8. A pump system according to claim 1, further comprising a sensor communication interface, via which the pump control is programmable.

9. A pump system, according to claim 8, wherein the sensor communication interface is integrated into the sensor electronics.

10. A pump system according to claim 8, further comprising a mobile communication device, by way of which the pump control is programmable via a wireless communication connection to the sensor communication interface.

11. A pump system according to claim 1, further comprising a control interface which is signal-connected to the motor control and via which the motor control of the pump unit can be commanded by way of the pump control.

12. A pump system according to claim 11, wherein the control interface is integrated into the sensor electronics and/or a sensor mains part.

13. A pump system according to claim 1, wherein the pump control is configured to command the motor control on the basis of the at least one parameter of the fluid which is detected by way of the sensor.

14. A pump system according to claim 1, wherein the pump control is configured to command the motor control of the pump unit in accordance with a selectable operating program.

15. A pump system according to claim 1, further comprising a second pump units for pumping the fluid, wherein the pump control is configured to command the motor control of the first pump unit and/or a motor control of the second pump unit (5) according to a selectable operating program.

16. A pump system according to claim 1, wherein the pump control is configured to command the motor control of the first pump unit and/or a motor control of a second pump unit with operating parameter commands comprising switch-on and switch-off commands, desired speed commands and/or desired power commands.

17. A pump control method comprising the steps of
detecting at least one parameter of a fluid in a pump of a first pump unit or in a pipe which is fluid-connected to the pump, by way of a sensor; and
commanding a motor control of the first pump unit by way of a pump control which is integrated into the sensor electronics of the sensor.

18. A pump control method according to claim 17, further comprising the step of programming the pump control via a sensor communication interface which is integrated into the sensor electronics and/or a sensor mains part.

19. A pump control method according to claim 18, wherein the step of the programming is effected by way of a mobile communication device and via a preferably wireless communication connection between the communication device and the sensor communication interface.

20. A pump control method according to claim 17, wherein the step of the commanding is effected on the basis of the at least one parameter of the fluid which is detected by way of the sensor.

21. A pump control method according to claim 17, wherein the step of the commanding comprises an operating parameter command, comprising a switch-on and switch-off command, a desired speed command and/or desired power command, for a drive motor of the first pump unit in accordance with a selectable operating program.

22. A pump control method according to claim 17, further comprising the step of commanding a motor control of a second of at least two pump units by way of the pump control which is integrated into the sensor electronics of the sensor, with operating parameter commands, such as for example switch-on and switch-off commands, desired speed commands and/or desired power commands.

23. A pump control method according to claim 22, wherein the operating parameter commands are commanded according to a selectable operating program.

24. A pump control method according to claim 23, wherein the operating program is selected from a group of operating programs with a first operating program, concerning which a second pump unit as a supplementary unit is connected to the first pump unit as a main unit, if the detected at least one parameter of the fluid indicates that the power of the first pump unit is not sufficient, wherein the second pump unit serves as main unit and the first pump unit as a supplementary unit, preferably in an alternating schedule.

25. A pump control method according to claim 17, further comprising the step of detecting a number of switch-on procedures and/or an operational running time of the first and/or a second pump unit, wherein the step of the commanding is effected on the basis of the detected number of switch-on procedures and/or the detected operational running time, of the first and/or second pump unit.
